(19) United States
(12) Patent Application Publication
(10) Pub. No.: US 2024/0286552 A1
(43) Pub. Date: Aug. 29, 2024

(54) VEHICLE ACCESS STEP STRUCTURE

(71) Applicant: TOYOTA JIDOSHA KABUSHIKI KAISHA, Aichi-ken (JP)

(72) Inventors: Shigenori HASHIDA, Nisshin-shi (JP); Shintaro KITAKATA, Nisshin-shi (JP)

(21) Appl. No.: 18/411,024

(22) Filed: Jan. 12, 2024

(30) Foreign Application Priority Data
Feb. 28, 2023 (JP) 2023-030061

(51) Int. Cl. B60R 3/00; B62D 21/15

(52) U.S. Cl. CPC B60R 3/002; B62D 21/157; B60L 50/66

(57) ABSTRACT

A vehicle access step structure includes: an energy absorption portion having an inner end, in a vehicle width direction, which is positioned below a side sill of a vehicle and which faces an outer end face, in the vehicle width direction, of a battery configured to supply electric power to an electric motor that is a drive source of the vehicle, the energy absorption portion exhibiting an energy absorption function by deforming upon application of an external force of a predetermined size or greater; a step portion positioned lower, and further toward an outer side, in the vehicle width direction, than the side sill, the step portion deforming upon application of the external force and exhibiting an energy absorption function together with the energy absorption portion; and an anti-slip portion provided at an upper surface of the step portion.

### CROSS-REFERENCE TO RELATED APPLICATION

This application claims priority under 35 USC 119 from Japanese Patent Application No. 2023-30061 filed on Feb. 28, 2023, the disclosure of which is incorporated by reference herein in its entirety.

### BACKGROUND

### Technical Field

The present disclosure relates to a vehicle access step structure.

### Related Art

An inner side end portion, in a vehicle width direction, of a crash box (energy absorption member) is fixed to a side face of a side sill of the vehicle of Japanese Patent Application Laid-open (JP-A) No. 2022-103640. An outer side end portion of the crash box is positioned further toward a vehicle width direction outer side than a side face of the vehicle body.

Therefore, a vehicle occupant can use the outer side end portion of the crash box as an access step.

When a different vehicle has collided with the outer side end of the crash box of this vehicle, for example, the crash box deforms so as to be compressed in the vehicle width direction, absorbing some of the collision load.

In order to increase the energy absorption capacity of a crash box, it is necessary to increase the vehicle width direction dimension of the crash box. However, if the vehicle width direction dimension of the crash box is increased in JP-A No. 2022-103640, the protrusion amount of the crash box toward the vehicle width direction outer side from the side face of the vehicle body becomes excessively large.

Further, since the crash box is provided at relatively high position, it is difficult for an occupant to use.

Further, there is room for improvement regarding a slip suppression function for when the foot of an occupant is placed on the crash box.

### SUMMARY

In consideration of the above circumstances, the present disclosure is to obtain an access step structure in vehicle that is easy for an occupant to use when getting in or out of the vehicle, and that makes it difficult for the occupant to slip, in which the protrusion amount of the step portion toward the side from the side sill does not become excessively large, and the access step structure is able to receive an impact force that has not been completely absorbed by the energy absorption portion, using a battery installed in the vehicle.

A vehicle access step structure of a first aspect of the present disclosure includes: an energy absorption portion having an inner end side, in a vehicle width direction, which is positioned below a side sill of a vehicle and which faces an outer end face, in the vehicle width direction, of a battery configured to supply electric power to an electric motor that is a drive source of the vehicle, the energy absorption portion exhibiting an energy absorption function by deforming upon application of an external force of a predetermined size or greater; a step portion positioned lower, and further toward an outer side, in the vehicle width direction, than the side sill, the step portion deforming upon application of the external force and exhibiting an energy absorption function together with the energy absorption portion; and an anti-slip portion provided at an upper surface of the step portion.

In the vehicle access step structure of the first aspect, the step portion is positioned below the side sill and at the outer side, in the vehicle width direction, of the side sill. An anti-slip portion is provided at an upper surface of the step portion. Therefore, a vehicle occupant can easily use the step portion as an access step.

An anti-slip portion is provided at an upper surface of the step portion. Therefore, the occupant does not slip easily when the occupant places his/her foot on the upper surface of the step portion.

In the vehicle access step structure of the first aspect, an inner side end portion, in the vehicle width direction, of each energy absorption portion is positioned below a side sill of the vehicle, and faces an outer side end face, in the vehicle width direction, of a battery that is capable of supplying electric power to an electric motor, serving as a drive source. Therefore, in cases in which the vehicle width direction dimensions of the energy absorption portion and the step portion are increased in order to increase the energy absorption capacity, the sideward projection amount of the outer side end portion of the step portion from the side sill does not become large.

Further, the step portion and the energy absorption portion are deformed when an external force of a magnitude equal to or greater than a predetermined amount is applied to the step portion and the energy absorption portion. Further, force that has not been absorbed by the energy absorption portion at this time can be transmitted from the inner side end portion of the energy absorption portion to the outer side end portion of the battery. In this manner, in the vehicle access step structure of the first aspect, impact force that has not been completely absorbed by the energy absorption portion can be received using a battery installed in the vehicle.

A vehicle access step structure of a second aspect of the present disclosure is the structure of the first aspect, in which the anti-slip portion includes at least one groove formed at the upper surface of the step portion and extending in a vehicle front-rear direction.

In the vehicle access step structure of the second aspect, at least one groove extending along the vehicle front-rear direction is formed at the upper surface of the step portion. Therefore, the upper surface of the step portion is less slippery than in cases in which no groove is formed.

A vehicle access step structure of a third aspect of the present disclosure is the structure of the second aspect, in which the access step structure including the groove is an extrusion molded article.

In the vehicle access step structure of the third aspect, an access step structure including a groove can be manufactured inexpensively.

A vehicle access step structure of a fourth aspect of the present disclosure is the stricture of the first aspect, in which an attachment groove extending in a vehicle front-rear direction is formed at the upper surface of the step portion, and the anti-slip portion includes an anti-slip member provided at the attachment groove.

In the vehicle access step structure of the fourth aspect, an attachment groove extending along the vehicle front-rear direction is formed at the upper surface of the step portion, and an anti-slip member is provided in the attachment groove. Namely, the step portion and the anti-slip member are manufactured as separate components. Therefore, the anti-slip member can be made of a material that is less slippery than the material of the step portion.

A vehicle access step structure of a fifth aspect of the present disclosure is the structure of the fourth aspect, in which a portion of the access step structure other than the anti-slip member is an extrusion molded article.

In the vehicle access step structure of the fifth aspect, it is possible to manufacture the access step structure inexpensively.

The vehicle access step structure according to the present disclosure has the excellent advantageous effects that it is easy for an occupant to use when getting in or out of the vehicle, and that it makes it difficult for the occupant to slip, the protrusion amount of the step portion toward the side from the side sill does not become large, and it is possible to receive impact force that has not been completely absorbed by the energy absorption portion, using a battery installed in the vehicle.

### BRIEF DESCRIPTION OF THE DRAWINGS

FIG. 1 is a perspective view illustrating a left side portion of a vehicle according to a first exemplary embodiment;

FIG. 2 is a cross-sectional view taken along line 2-2 in FIG. 1;

FIG. 3 is an exploded perspective view of an energy absorption member; and

FIG. 4 is a cross-sectional view similar to FIG. 2 of a second exemplary embodiment.

### DETAILED DESCRIPTION

Explanation follows regarding a first exemplary embodiment of a vehicle access step structure according to the present disclosure, with reference to appended drawings. Note that in each of the drawings, as appropriate, the arrow FR indicates the front in the vehicle front-rear direction, the arrow LH indicates leftward in the vehicle left-right direction, and the arrow UP indicates upward in the vehicle vertical direction. In the following explanation, the front-rear direction, the left-right direction, and the vertical direction respectively indicate the vehicle front-rear direction, the vehicle left-right direction, and the vehicle vertical direction.

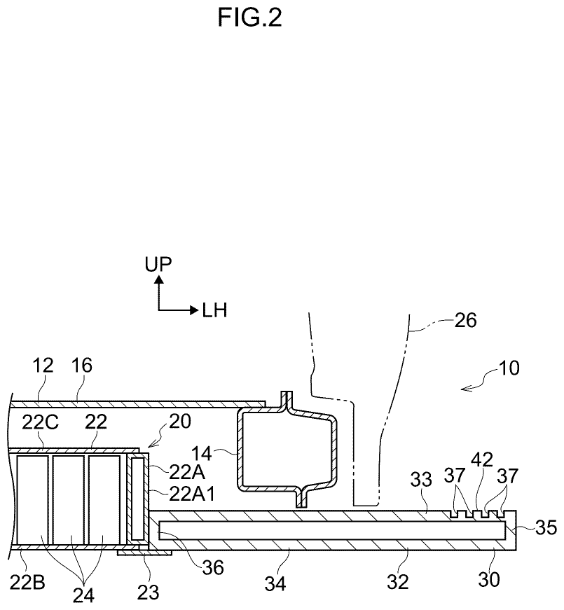

As illustrated in FIG. 2, the vehicle body 12 of the vehicle 10 includes a left and right pair of side sills (rockers) 14 (only one of which is illustrated in FIG. 2) extending in the front-rear direction, and a floor pan 16 connected to left and right side sills 14. The side sills 14 and the floor pan 16 are made of metal.

A battery 20 is provided in a space surrounded by the left and right side sills 14 and the floor pan 16. The battery 20 includes a battery case 22 that is a hollow box-like member, and plural battery stacks 24 housed inside the battery case 22. Note that each battery stack 24 includes plural battery cells. The battery case 22 can be made of metal, for example. The battery case 22 includes a battery frame 22A having a rectangular planar shape, a bottom plate 22B that closes off a bottom face of the battery frame 22A, and an upper plate 22C that closes off an upper face of the battery frame 22A. Further, the battery frame 22A includes a left and right pair of side frames 22A1 extending in the front-rear direction (only one of which is illustrated in FIG. 2). Coupling plates 23 are fixed to the lower surfaces of the left and right side frames 22A1, respectively. A right end portion of the right side coupling plate 23 projects out further toward the right side than the right side frame 22A1, and a left end portion of the left side coupling plate 23 projects out further toward the left side than the left side frame 22A1. A right end portion of the battery case 22 is positioned at a left side of the right side sill 14, and a left end portion of the battery case 22 is positioned at a right side of the left side sill 14. The vehicle 10 includes an electric motor (not illustrated) as a drive source. The battery 20 (the battery stack 24) is capable of supplying electric power to the electric motor, and is capable of storing electric power generated by the electric motor. Therefore, the battery 20 is large in size and weight.

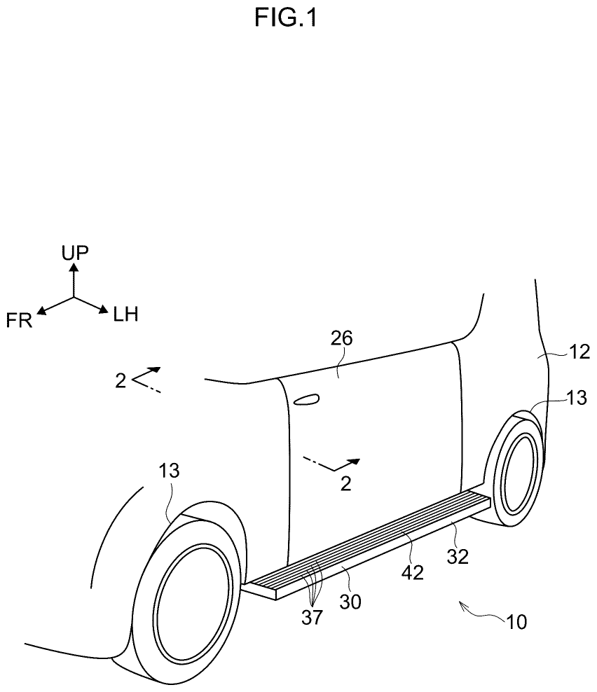

As illustrated in FIGS. 1 and 2, the vehicle 10 includes a left and right pair of slide doors 26. As illustrated in FIG. 2, a position, in the vertical direction, of the lower end portion of the slide door 26 is substantially the same as the lower end portion of the side sill 14.

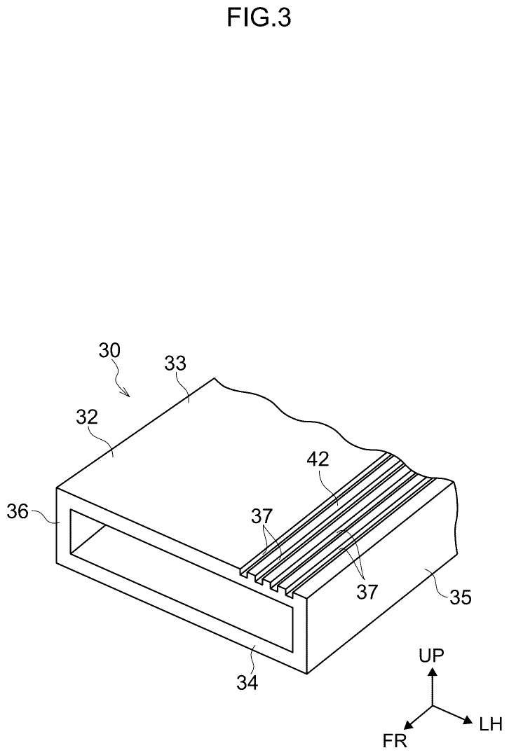

As illustrated in FIGS. 1 and 2, the vehicle 10 includes a left and right pair of energy absorption members 30 (only one of which is illustrated in each of FIGS. 1 and 2). As illustrated in FIG. 3, each energy absorption member 30 includes a base portion 32. The energy absorption member 30 can be made of metal or resin. The base portion 32, which is a box-shaped member that is open at both front and rear ends and has a substantially rectangular cross-section, can be manufactured by extrusion molding. Namely, the base portion 32 can be integrally molded while being extruded in a length direction (front-rear direction) of the base portion 32 by an extruder, not illustrated in the drawings. The base portion 32 includes an upper plate portion 33, a bottom plate portion 34, an outer side plate portion 35, and an inner side plate portion 36. Namely, the cross-section of the base portion 32 when cut along a plane perpendicular to the front-rear direction of the base portion 32 is substantially rectangular. The upper plate portion 33 and the bottom plate portion 34 are rectangular flat plates that are parallel to each other, and the planar shapes of the upper plate portion 33 and the bottom plate portion 34 are substantially the same. The outer side plate portion 35 and the inner side plate portion 36 are rectangular flat plates that are parallel to each other, and the side face shapes of the outer side plate portion 35 and the inner side plate portion 36 are substantially the same. The outer side plate portion 35 connects outer side end portions, in the left and right direction, of the upper plate portion 33 and the bottom plate portion 34 to each other, and the inner side plate portion 36 connects inner side end portions, in the left and right direction, of the upper plate portion 33 and the bottom plate portion 34 to each other. Plural grooves (anti-slip portions) 37 are formed at the outer side end portion of the upper surface of the upper plate portion 33 during extrusion molding. Each groove 37 is parallel to the front-rear direction. Four grooves 37 are formed at the upper plate portion 33 of the present exemplary embodiment; however, the number of the grooves 37 may be one or a plural number other than four.

As illustrated in FIG. 1, the left and right energy absorption members 30 are positioned between front and rear wheel houses 13. Further, as illustrated in FIG. 2, each energy absorption member 30 is positioned below the side sill 14. An inner side end portion, in the left-right direction, of each energy absorption member 30 contacts the side frame 22A1 of the battery case 22 of the battery 20. An inner side end portion of each energy absorption member 30 is fixed to the corresponding side frame 22A1 and coupling plate 23 by a coupling member (not illustrated).

A portion of each energy absorption member 30 projects out further toward outer sides, in the left and right direction, than the side sills 14. A portion of each energy absorption member 30 may or may not project out further toward outer sides, in the left and right direction, than the slide doors 26. A portion of each energy absorption member 30 projecting sideward from the side sill 14 is a step portion 42. Respective grooves 37 are formed at the upper surface of the step portion 42. Further, an upper plate portion 33 of each energy absorption member 30 is fixed to the side sill 14 via a connecting member (not illustrated). Note that portions of the energy absorption members 30 other than the step portions 42 are “energy absorption portions”.

The left and right energy absorption members 30 fixed to the vehicle body 12 and the battery 20 in this manner function as crash boxes, described below.

### Mechanism and Effect

Explanation follows regarding the mechanism and advantageous effects of the first exemplary embodiment.

The step portions 42 of the left and right energy absorption members 30 are positioned further toward outer sides, in the left and right direction, than the corresponding side sills 14. Therefore, in cases in which the slide door 26 is in an open state, the occupant of the vehicle 10 can perform a boarding or disembarking operation with respect to the vehicle 10 while resting his/her foot (shoe) on the upper surface of the step portion 42 of the energy absorption member 30.

The step portion 42 of each energy absorption member 30 is positioned lower than the corresponding side sill 14. Therefore, compared to cases in which position of the step portion 42, in the vertical direction, is the same as the side sill 14, the occupant of the vehicle 10 can easily use each step portion 42 as a boarding and disembarking step.

A groove 37 extending along the front-rear direction is formed at the upper face of the step portion 42. Therefore, compared to cases in which the groove 37 is not formed at the step portion 42, the foot of the occupant is less likely to slip with respect to the upper surface of the step portion 42.

An inner side end portion in the left-right direction of each energy absorption member 30 is positioned below the side sill 14, and faces an outer side end face, in the vehicle width direction, of the battery 20. Therefore, in cases in which the vehicle width direction dimension of the energy absorption member 30 is increased in order to increase the energy absorption capacity, compared to cases in which the energy absorption member 30 is positioned at the same height as the side sill 14, the sideward projection amount of each energy absorption member 30 with respect to the corresponding side sill 14 (the side face of the vehicle body 12) is unlikely to be excessively large.

A case is assumed in which another vehicle has collided with an outer side end portion (step portion 42) of each energy absorption member 30 in the left-right direction. An external force in the left-right direction is applied to the energy absorption member 30 from another vehicle at this time. When the magnitude of this external force is equal to or greater than a predetermined value, the energy absorption member 30 is deformed so as to be compressed in the left-right direction. Namely, the energy absorption member 30 functions as a crash box, and exhibits an energy absorption function. Force that has not been fully absorbed by the energy absorption member 30 at this time is transmitted from the inner side end portion of the energy absorption member 30 to the outer side end portion of the battery 20 (the battery case 22). This enables the impact force generated when the energy absorption member 30 is compressed in the left-right direction to be received using the battery 20, which has a large weight.

The base portion 32 of the present exemplary embodiment is an extruded article. This enables the base portion 32 in which the groove 37 is formed to be manufactured inexpensively.

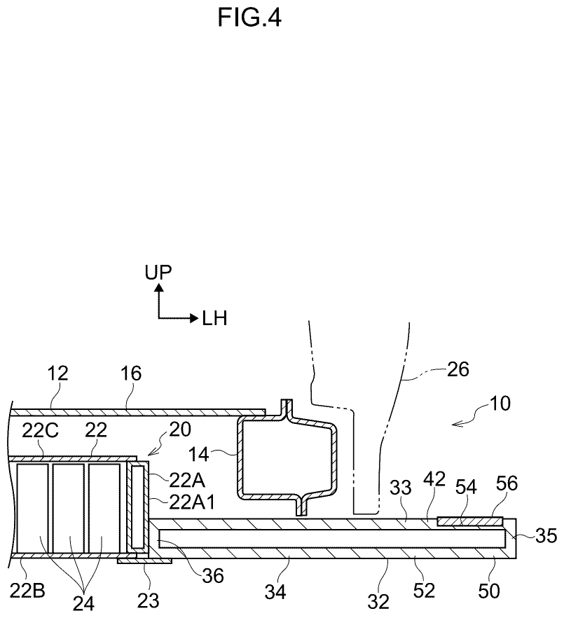

Explanation follows regarding a second exemplary embodiment of a vehicle access step structure according to the present disclosure, with reference to FIG. 4. Note that the same reference numerals are appended to the same members as in the first exemplary embodiment, and detailed explanation thereof is omitted.

Each energy absorption member 50 provided to the vehicle 10 of the second exemplary embodiment includes a main body portion 52 and an anti-slip member (anti-slip portion) 56. The main body portion 52 includes the base portion 32. However, on the upper surface of the step portion 42 (the upper plate portion 33) of the base portion 32 of the present exemplary embodiment, a single attachment groove 54 is formed instead of the plural grooves 37. The attachment groove 54 extends along the front-rear direction. The attachment groove 54 is also formed at the upper plate portion 33 during extrusion molding of the base portion 32. Namely, the base portion 32 of the present exemplary embodiment is also an extruded product. This enables the base portion 32 including the attachment groove 54 to be manufactured inexpensively.

The anti-slip member 56 is an elongate member extending in the front-rear direction with substantially the same shape as the attachment groove 54. The anti-slip member 56 can be manufactured from a different material from a material of the main body portion 52. For example, the anti-slip member 56 can be an integrally molded article made of resin. The material configuring the anti-slip member 56 is a material that tends to have a large coefficient of friction with shoes worn by an occupant. The anti-slip member 56 is inserted into the attachment groove 54, and is fixed to an inside face (the upper plate portion 33) of the attachment groove 54. The anti-slip member 56 and the attachment groove 54 can be fixed by, for example, an adhesive agent. When the anti-slip member 56 is fixed to the attachment groove 54, the upper face of the anti-slip member 56 is positioned slightly above the upper face of the upper plate portion 33.

The basic structure of the energy absorption member 50 of the present exemplary embodiment is that of the energy absorption member 30 of the first exemplary embodiment, and further, the energy absorption member 50 is fixed to the vehicle body 12 and the battery 20 in the same manner as the energy absorption member 30. Thus, the energy absorption member 50 can exhibit the same mechanism and effect as the energy absorption member 30.

The anti-slip member 56 provided at the energy absorption member 50 of the present exemplary embodiment is manufactured from a material that tends to have a large coefficient of friction with shoes worn by an occupant. Therefore, there is less risk of the foot of the occupant slipping relative to the upper surface of the step portion 42 when the occupant places his/her foot (shoe) on the upper surface of the step portion 42.

Explanation has been given regarding access step structures in vehicles according to the first and the second exemplary embodiments; however, the present disclosure may be appropriately modified in design within a range that does not depart from the scope of the present disclosure.

For example, it is not necessary to fix the inner side end portions of the respective energy absorption members 30, 50 to the battery case 22.

An inner side end portion of each of the energy absorption members 30, 50 and an outer side end face in the left-right direction of the battery case 22 may face each other in the left-right direction with a small gap formed therebetween. In such cases, as well, when the energy absorption members 30, 50 have been deformed so as to be compressed in the left-right direction, force is transmitted to an outer side end portion of the battery 20 (the battery case 22) from the inner side end portions of the energy absorption members 30, 50 that have been deformed so as to approach the battery case 22 side. This enables the impact force generated when the energy absorption members 30, 50 are compressed in the left-right direction to be received using the battery 20, which has a large weight.

A groove extending along the front-rear direction may be formed at the upper face of the anti-slip member 56.

The cross-section shape when cut along a plane orthogonal to the front-rear direction of the base portion 32 may be a polygon or a substantial polygon different from a substantial rectangle.

The inner side end portions in the left and right direction of each energy absorption member 30, 50 and the battery case 22 of the battery 20 may be fixed using bolts and nuts, instead of using the connecting plate 23.

When the anti-slip member 56 is fixed to the attachment groove 54, the upper face of the anti-slip member 56 may be positioned at the same vertical direction position as the upper face of the upper plate portion 33 or lower than the upper face of the upper plate portion 33.

The door provided at the vehicle 10 may be a swing-type door rather than a slide door.

What is claimed is:

1. A vehicle access step structure, the structure comprising:
an energy absorption portion having an inner end, in a vehicle width direction, which is positioned below a side sill of a vehicle and which faces an outer end face, in the vehicle width direction, of a battery configured to supply electric power to an electric motor that is a drive source of the vehicle, the energy absorption portion exhibiting an energy absorption function by deforming upon application of an external force of a predetermined size or greater;
a step portion positioned lower, and further toward an outer side, in the vehicle width direction, than the side sill, the step portion deforming upon application of the external force and exhibiting an energy absorption function together with the energy absorption portion; and
an anti-slip portion provided at an upper surface of the step portion.

2. The vehicle access step structure of claim 1, wherein the anti-slip portion comprises at least one groove formed at the upper surface of the step portion and extending in a vehicle front-rear direction.

3. The vehicle access step structure of claim 2, wherein the access step structure having the groove is an extrusion molded article.

4. The vehicle access step structure of claim 1, wherein:
an attachment groove extending in a vehicle front-rear direction is formed at the upper surface of the step portion, and
the anti-slip portion comprises an anti-slip member provided at the attachment groove.

5. The vehicle access step structure of claim 4, wherein a portion of the access step structure other than the anti-slip member is an extrusion molded article.
